(19) United States
(12) Patent Application Publication
(10) Pub. No.: US 2026/0175655 A1
(43) Pub. Date: Jun. 25, 2026

(54) VEHICLE EXTERIOR PANEL

(71) Applicant: TOYODA GOSEI CO., LTD., Kiyosu-shi (JP)

(72) Inventors: Masayuki KITASHIBA, Kiyosu-shi (JP); Akira Horiyama, Kiyosu-shi (JP); Akihiro Sakakibara, Kiyosu-shi (JP)

(21) Appl. No.: 19/407,473

(22) Filed: Dec. 3, 2025

(30) Foreign Application Priority Data
Dec. 24, 2024 (JP) 2024-226987

(51) Int. Cl. B60J 5/10; B60J 1/20

(52) U.S. Cl. CPC B60J 5/107; B60J 1/2094

(57) ABSTRACT

A vehicle exterior panel includes a panel body and a protector. The panel body is configured to be attached to an exterior member forming a part of an outer shell of a vehicle. The protector is formed of an elastic material and extends along a peripheral edge of the panel body between the panel body and the exterior member. The panel body includes a base material made of a resin, and a decorative layer laminated on an outer surface of the base material. The protector includes an extending portion that extends from between the panel body and the exterior member and covers, from an outer side, a boundary between the decorative layer and the base material. The boundary is located at the peripheral edge of the panel body.

### CROSS-REFERENCE TO RELATED APPLICATIONS

This application is based upon and claims the benefit of priority from Japanese Patent Application No. 2024-226987, filed on December 24, 2024, the entire contents of which are incorporated herein by reference.

### BACKGROUND

### 1. Field

The present disclosure relates to an exterior panel for a vehicle.

### 2. Description of Related Art

JPH05-069782A discloses a decorative trim panel mounted to a vehicle body back panel through a single elongated cushion member.

Such a method is disclosed in JP2005-161683A, in which a coating film is formed on the surface of a decorative trim panel by an in-mold coating process. In this process, a molten thermoplastic resin is first injected into a base-material molding cavity defined between a fixed mold and a first movable mold and then allowed to solidify. This forms a base material having a sealing ridge at a position contacting the parting line. After the first movable mold is replaced with a second movable mold, the base material is placed on the fixed mold, and the fixed mold and the second movable mold are clamped together. A paint material is then introduced into a coating-film forming cavity defined between the surface of the base material and the second movable mold and subsequently cured. During this process, the sealing ridge pressed against the second movable mold prevents the paint from leaking toward the parting line. As a result, a decorative trim panel having a coating film formed on the surface of the base material is obtained.

In conventional vehicle exterior panels produced by such an in-mold coating process, including those having decorative trim panels as described above, it is difficult to extend the coating-film forming cavity to a position contacting the parting line without risking paint leakage. Consequently, at the peripheral edge of the vehicle exterior panel, a portion of the base material that is not covered by the coating film remains exposed. This exposed portion is susceptible to deterioration caused by ultraviolet radiation. In addition, because the boundary between the coating film and the base material is visible from the outside at the peripheral edge of the vehicle exterior panel, the aesthetic appearance of the decorative trim panel is also impaired.

These issues are not limited to vehicle exterior panels in which the coating film is formed by an in-mold coating process. Similar problems may also arise in vehicle exterior panels formed by injection molding a base material using a film as an insert member.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior panel includes a panel body configured to be attached to an exterior member forming a part of an outer shell of a vehicle, and a protector formed of an elastic material and extending along a peripheral edge of the panel body between the panel body and the exterior member. The panel body includes a base material made of a resin and a decorative layer laminated on an outer surface of the base material. The protector includes an extending portion that extends from between the panel body and the exterior member and covers, from an outer side, a boundary between the decorative layer and the base material. The boundary is located at the peripheral edge of the panel body.

Other features and aspects will be apparent from the following detailed description, the drawings, and the claims.

### BRIEF DESCRIPTION OF THE DRAWINGS

FIG. 1 is a perspective view showing a vehicle including a trunk lid to which a vehicle exterior panel according to an embodiment is attached.

FIG. 2 is a cross-sectional view taken along line 2-2 in FIG. 1.

FIG. 3 is a rear view showing the vehicle exterior panel of FIG. 1.

FIG. 4 is an enlarged rear view of a connecting portion shown in FIG. 3.

FIG. 5 is a cross-sectional view taken along line 5-5 of FIG. 4.

FIG. 6 is a cross-sectional view taken along line 6-6 in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a vehicle exterior panel will be described with reference to FIGS. 1 to 6. Hereinafter, the front and the rear in the longitudinal direction of the vehicle 10 will be simply referred to as the front and the rear. Further, the width direction of the vehicle 10 will be simply referred to as the vehicle width direction, and the right side and the left side in the vehicle width direction when viewing the front from the rear of the vehicle 10 will be simply referred to as the right side and the left side. Further, the upper side and the lower side in the up-down direction of the vehicle 10 when the vehicle 10 is located on a horizontal plane will be simply described as the upper side and the lower side. Hereinafter, in the longitudinal direction, the vehicle width direction, and the up-down direction, a side away from the center of the vehicle 10 may be referred to as an outer side, and a side close to the center of the vehicle 10 may be referred to as an inner side.

### Vehicle

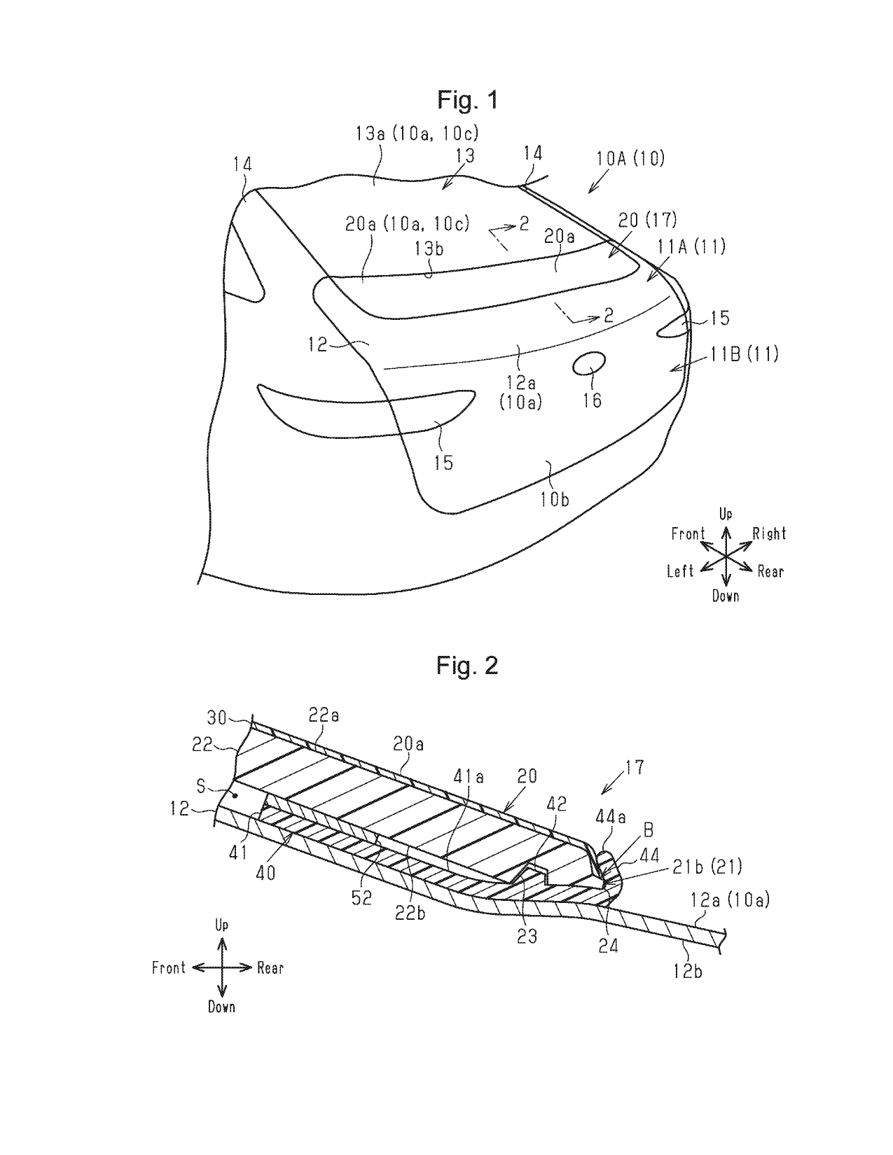

As shown in FIGS. 1 and 2, a trunk lid 11 for opening and closing an opening of a luggage compartment (not shown) is provided on a rear side 10A of the vehicle 10. The trunk lid 11 includes an outer panel 12 constituting an outer shell of the trunk lid 11, and an inner panel (not shown) joined to an inner surface 12b of the outer panel 12. The outer panel 12 corresponds to an exterior member. The outer panel 12 and the inner panel are formed by, for example, press molding a plate material made of a metal such as aluminum or an aluminum alloy.

The trunk lid 11 includes a lid upper surface portion 11A that covers the opening of the luggage compartment from above, and a lid rear surface portion 11B that covers the opening of the luggage compartment from the rear. The lid upper surface portion 11A extends rearward while being inclined continuously from the rear window 13 and the pair of C pillars 14 adjacent to both left and right sides of the rear window 13. In the present embodiment, the lid upper surface portion 11A is integrated with the rear window 13 and the pair of C pillars 14 to constitute an upper surface 10a as one inclined surface (see FIG. 1). The upper surface 10a extends in the longitudinal direction and the vehicle-width direction, and is gently inclined so as to be located lower toward the rear. A vehicle exterior panel (hereinafter, exterior panel 17) is attached to an outer surface 12a of the lid upper surface portion 11A. The lid rear surface portion 11B is bent from the rear edge of the lid upper surface portion 11A and extends downward, and constitutes a part of the rear surface 10b of the vehicle 10. For example, a part of the rear lamp 15 and the emblem 16 are disposed on the lid rear surface portion 11B.

### Exterior Panel

As shown in FIGS. 1 to 3, the exterior panel 17 includes a panel body 20 and a protector 40. The panel body 20 has a plate shape having a thickness in the up-down direction in a plan view, and is longer in the vehicle width direction than in the longitudinal direction as a whole. The panel body 20 extends rearward while being continuously inclined from a rear edge 13b of the rear window 13. In the present embodiment, the outer surface 20a of the panel body 20 is flush with the outer surface 13a of the rear window 13. The outer surface 20a of the panel body 20 and the outer surface 13a of the rear window 13 constitute an integrated design surface 10c that mainly constitutes the upper surface 10a (see FIG. 1).

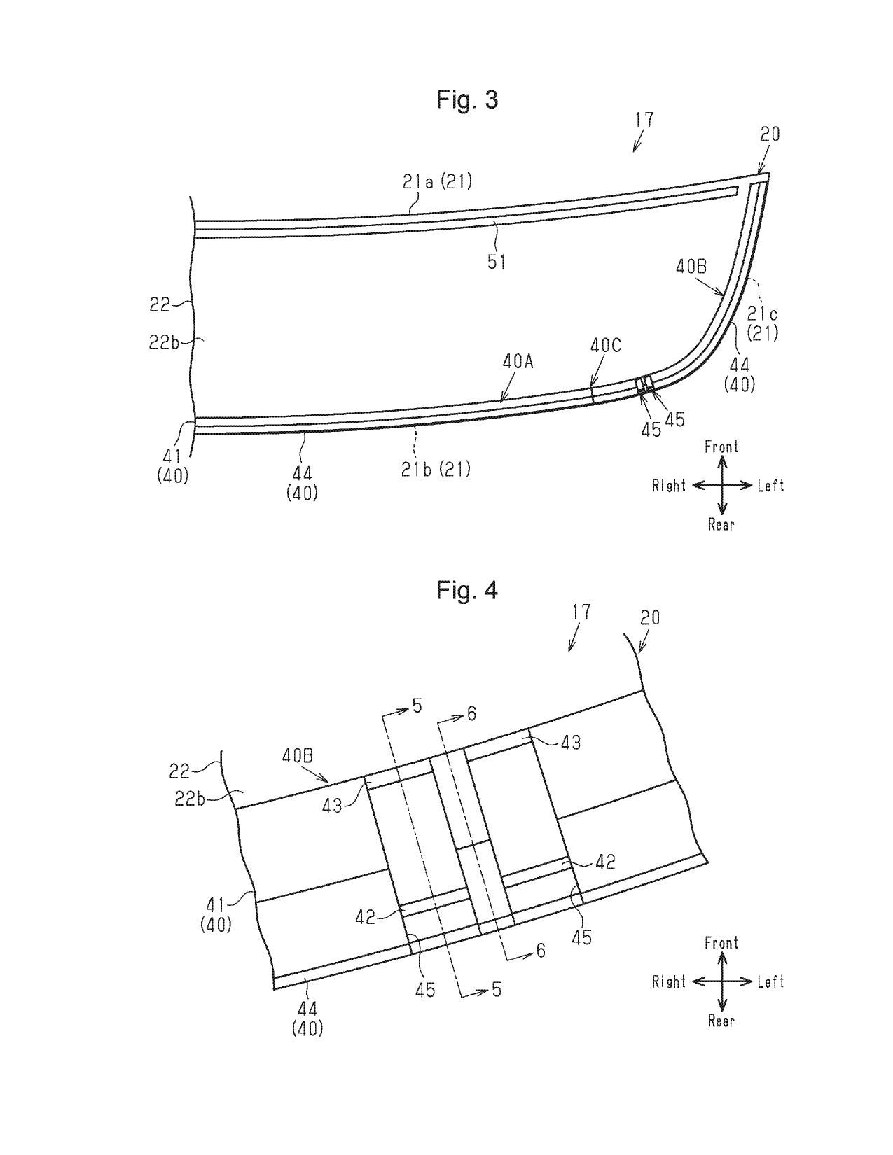

As shown in FIG. 3, the peripheral edge 21 of the panel body 20 is constituted by a front edge 21a, a rear edge 21b, and a pair of side edge 21c. Each of the front edge 21a and the rear edge 21b extends in the vehicle widthwise direction. The pair of side edges 21c extend in the longitudinal direction and couple the front edge 21a and the rear edge 21b to each other. In a state where the exterior panel 17 is attached to the outer panel 12, the rear edge 21b is located below the front edge 21a. The edge and the peripheral edge as used herein correspond to an end face of the panel body 20 in a surface direction of the panel body 20.

As shown in FIG. 2, the panel body 20 includes a resin-made base material 22 and a decorative layer 30 laminated on an outer surface 22a of the base material 22. Examples of the resin material forming the base material 22 include an acrylic resin such as a polymethyl methacrylate resin (PMMA) and a thermoplastic resin such as a polycarbonate resin (PC). A groove 23 opening toward a protector body 41 to be described later is formed in an inner surface 22b of the base material 22. The groove 23 functions to fix the base material 22 to a mold in such a manner that a convex portion of the mold is fitted into the groove 23 when the exterior panel 17 is formed using the in-mold coating molding method. In the present embodiment, one groove 23 is formed in the inner surface 22b along the entire rear edge 21b and the pair of side edge 21c. On the other hand, a portion of the inner surface 22b located on the front edge 21a side is a flat surface in which the groove 23 is not formed (see FIG. 3). In this portion, a double-sided tape 51 for joining the inner surface 22b and the outer surface 12a of the outer panel 12 is provided along the front edge 21a. An exposed portion 24 exposed to the peripheral edge 21 of the panel body 20 is formed on the peripheral edge of the base material 22. The exposed portion 24 is provided over the entire peripheral edge 21.

The decorative layer 30 is a coating film made of a thermosetting resin. The decorative layer 30 is colored in glossy black in accordance with the color of the rear window 13. Examples of the thermosetting resin forming the decorative layer 30 include thermosetting polyurethane. In the present embodiment, the decorative layer 30 is formed using an in-mold coating molding method. Specifically, a cavity formed between the outer surface 22a of the base material 22 and a molding die (not shown) is filled with a coating material obtained by mixing a heat-curable polyurethane and a black pigment such as carbon black, and the coating material is cured. As a result, the panel body 20 in which the decorative layer 30 is formed on the outer surface 22a of the base material 22 is formed.

### Protector

As shown in FIGS. 2 and 3, the protector 40 has a single elongated shape extending along the peripheral edge 21 of the panel body 20. The protector 40 includes a protector body 41 and an extending portion 44. The protector body 41 is disposed between the panel body 20 and the outer panel 12. The extending portion 44 extends from between the panel body 20 and the outer panel 12. The protector body 41 extends along the entire rear edge 21b and the entire pair of side edges 21c between the panel body 20 and the outer panel 12. The protector body 41 is joined to the outer surface 12a of the outer panel 12 via an adhesive or a pressure-sensitive adhesive (not shown).

As shown in FIGS. 2, 5, and 6, the protector body 41 is formed with a ridge 42 that protrudes from the outer surface 41a and fits into the groove 23 of the base material 22. The ridge 42 extends along the whole of the rear edge 21b and the pair of side edge 21c corresponding to the groove 23.

A double-sided tape 52 for joining the outer surface 41a of the protector body 41 and the inner surface 22b of the base material 22 is provided on a portion of the outer surface 41a of the protector body 41 which is located in front of the ridge 42 (see FIG. 2). In the present embodiment, the multiple double-sided tapes 52 are arranged at intervals in the extending direction of the protector body 41. In a portion of the outer surface 41a where the double-sided tape 52 is not provided in the extending direction of the protector body 41, a contact portion 43 for filling a clearance between the protector body 41 and the base material 22 is formed (see FIG. 6). The contact portion 43 protrudes from the outer surface 41a and is in contact with the inner surface 22b.

The extending portion 44 extends from the protector body 41 and extends upward along the rear edge 21b and the pair of side edges 21c of the panel body 20. The extending portion 44 is formed along the entirety of the rear edge 21b and the pair of side edges 21c (see FIG. 3). The extending portion 44 covers a boundary B between the decorative layer 30 and the exposed portion 24 of the base material 22 from the outside. The distal end surface 44a of the extending portion 44 is flush with the decorative layer 30, that is, the outer surface 20a of the panel body 20.

As shown in FIG. 3, the protector 40 is constituted by an intermediate portion 40A and a pair of side portions 40B. The intermediate portion 40A extends along the rear edge 21b. The pair of side portions 40B extend along the pair of side edges 21c on both left and right sides of the intermediate portion 40A. FIG. 3 shows only a left portion of the exterior panel 17. In the present embodiment, the intermediate portion 40A is formed by extrusion using an elastic material. The pair of side portions 40B are formed by an injection-molding method using an elastic material. The intermediate portion 40A and the pair of side portions 40B are joined to each other by any method such as welding at a joining portion 40C indicated by a solid line in FIG. 3. Examples of the elastic material forming the protector 40 include elastomer, rubber, and the like. In the present embodiment, the protector 40 is made of rubber. In the present embodiment, the protector 40 is colored in black, which is the same color as the decorative layer 30.

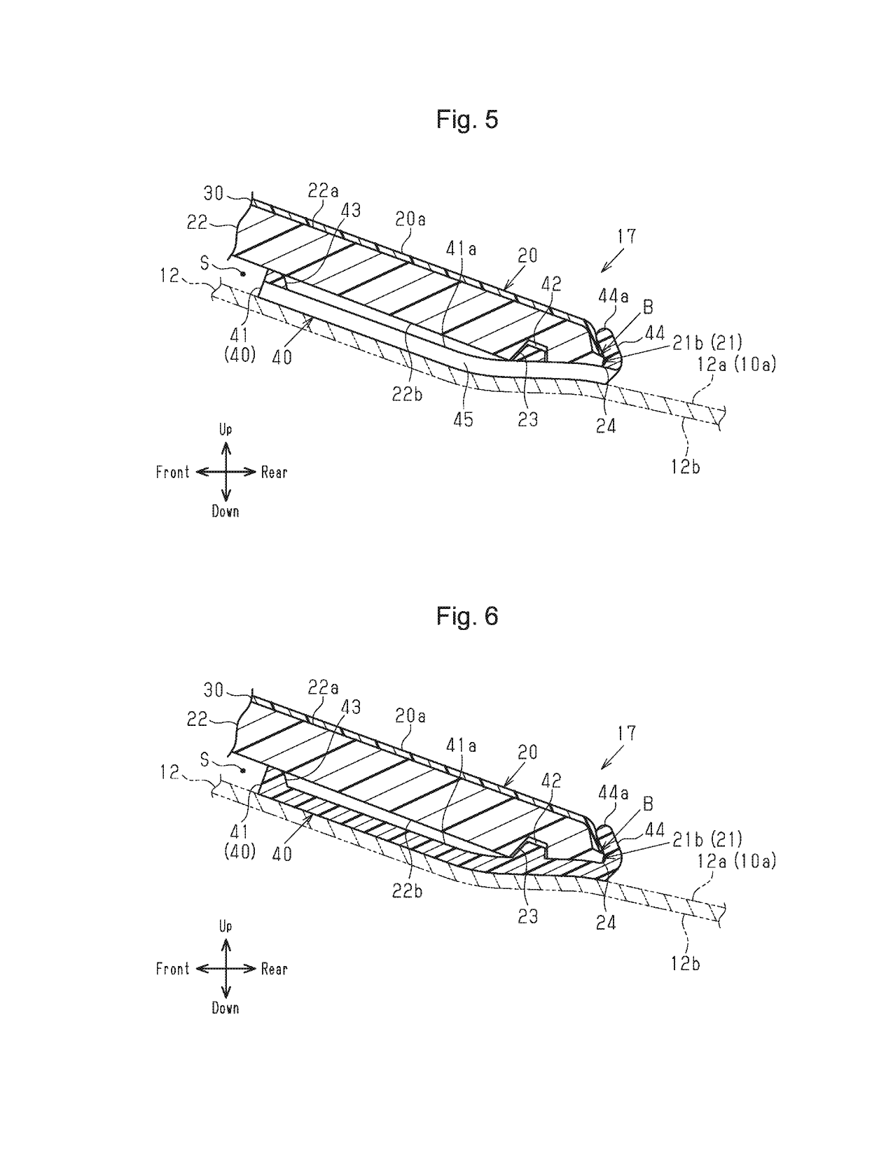

As shown in FIGS. 3 to 6, a pair of connecting portions 45 formed by cutting out the protector body 41 are formed on the side portions 40B of the protector 40. The connecting portions 45 extend in the longitudinal direction and open downward at the peripheral edge of the protector 40, that is, at the peripheral edge of the exterior panel 17 (see FIG. 5). Each of the connecting portions 45 communicates an internal space S surrounded by the outer panel 12, the protector body 41, and the base material 22 with the outside of the exterior panel 17. The pair of connecting portions 45 are spaced apart from each other in the vehicle width direction (see FIGS. 4 and 6). Each of the ridge 42 and the contact portion 43 continuously extends also in the connecting portion 45.

Operation of the Present Embodiment

The extending portion 44 of the protector 40 covers, from the outer side, the boundary B between the decorative layer 30 and the exposed portion 24 of the base material 22 located at the rear edge 21b and the two side edges 21c of the peripheral edge 21 of the panel body 20. Therefore, the base material 22 is prevented from being exposed to the outside at the peripheral edge of the exterior panel 17. As a result, deterioration of the base material 22 due to ultraviolet rays is suppressed. Accordingly, the boundary B is less likely to be visually recognized from the rear side. As a result, the appearance of the exterior panel 17 is prevented from being impaired due to the boundary B being visually recognized from the rear.

### Advantages of the Present Embodiment

(1) The exterior panel 17 includes the panel body 20 and the protector 40. The panel body 20 is configured to be attached to the outer panel 12 serving as an exterior member. The protector 40 is formed of rubber. The protector 40 extends between the panel body 20 and the outer panel 12 along the entirety of the rear edge 21b and the two side edges 21c of the panel body 20. The panel body 20 includes the base material 22 made of a thermoplastic resin, and the decorative layer 30 as a coating film laminated on the outer surface 22a of the base material 22. The protector 40 includes the extending portion 44, which extends from between the panel body 20 and the outer panel 12 and covers, from the outer side, the boundary B between the decorative layer 30 and the base material 22 located at the rear edge 21b and the two side edges 21c of the peripheral edge 21 of the panel body 20.

This configuration operates in the above-described manner. Therefore, it is possible to improve the appearance of the exterior panel 17 while suppressing deterioration of the base material 22.

Further, according to the above-described configuration, the protector 40 located between the base material 22 and the outer panel 12 is made of rubber. Therefore, the protector 40 can suppress problems such as generation of abnormal noise due to direct contact between the base material 22 and the outer panel 12, and peeling of a coating (not shown) of the outer panel 12.

(2) The protector 40 includes the connecting portions 45. The connecting portions 45 connect the internal space S, surrounded by the outer panel 12, the protector body 41, and the base material 22, to the outside of the exterior panel 17.

According to such a configuration, since the connecting portions 45, which allow the internal space S and the outside of the exterior panel 17 to communicate with each other is formed in the protector 40, for example, water that has entered the internal space S during washing of the vehicle 10 or the like is discharged to the outside through the connecting portions 45. Therefore, accumulation of water in the internal space S can be suppressed.

(3) The connecting portions 45 open downward at the peripheral edge of the exterior panel 17.

According to such a configuration, since the connecting portions 45 open downward at the peripheral edge of the exterior panel 17, water that has entered the internal space S surrounded by the outer panel 12, the protector body 41, and the base material 22 is efficiently discharged to the outside through the connecting portions 45. Therefore, accumulation of water in the internal space S can be further suppressed.

In particular, since the exterior panel 17 of the present embodiment is attached to the outer panel 12 of the trunk lid 11, when the trunk lid 11 is opened, water accumulated in the internal space S may leak from the front edge side of the exterior panel 17. In this regard, according to the above-described configuration, when the trunk lid 11 is at the closed position at which the trunk lid 11 closes the opening of the luggage compartment, water is discharged to the outside from the connecting portions 45. Therefore, it is possible to suppress leakage of water from the front edge side of the exterior panel 17 when the trunk lid 11 is opened.

(4) The groove 23 is formed in the inner surface 22b of the base material 22. The ridge 42 to be fitted into the groove 23 is formed in the outer surface 41a of the protector body 41.

According to such a configuration, when the protector 40 is attached to the panel body 20, the protector 40 is easily located by fitting the ridge 42 of the protector 40 into the groove 23 of the base material 22. Therefore, the protector 40 can be easily assembled to the panel body 20.

The exterior panel 17 of the present embodiment is formed by an in-mold coating molding method. Therefore, the groove 23 formed in the base material 22 in the process of the in-mold coating and molding method can be used as a positioning groove for fitting the ridge 42. Accordingly, it is not necessary to separately provide a groove for positioning in the base material 22. Therefore, the configuration of the base material 22 can be simplified.

(5) The protector 40 is colored in black, which is a color identical to that of the decorative layer 30. The distal end surface 44a of the extending portion 44 is flush with the outer surface 20a of the panel body 20.

According to such a configuration, the extending portion 44 of the protector 40 colored in the same color as the decorative layer 30 extends to a position flush with the outer surface 20a of the panel body 20. For this reason, the boundary between the decorative layer 30 and the extending portion 44 is likely to appear to be smoothly continuous when viewed from the outside. As a result, the boundary becomes inconspicuous. Therefore, it is possible to further improve the appearance of the exterior panel 17.

(6) The exterior member is the outer panel 12, which forms the outer shell of the trunk lid 11, which opens and closes the opening of the luggage compartment of the vehicle 10. The panel body 20 is provided at a position continuous with the rear edge 13b of the rear window 13 of the vehicle 10. The outer surface 20a of the panel body 20 is flush with the outer surface 13a of the rear window 13. The decorative layer 30 is colored in black, which is a color identical to that of the rear window 13.

According to such a configuration, since the color of the decorative layer 30 is colored in glossy black in accordance with the color of the rear window 13, it is possible to express a design as if the rear window 13 is extended to the trunk lid 11 by the design surface 10c unified in black.

When the trunk lid 11 is opened, the rear edge of the exterior panel 17 is displaced upward with the rotation of the trunk lid 11. Therefore, in the case of a conventional exterior panel without the extending portion 44 of the protector 40, the boundary B between the decorative layer 30 located at the rear edge and the exposed portion 24 of the base material 22 is raised to the height of the eyes of a person who opens the trunk lid 11, so that the boundary B is more easily visually recognized. In this regard, according to the above-described configuration, the extending portion 44 of the protector 40 suitably exhibits the effect of making the boundary B less visible. Therefore, it is possible to further suppress the appearance of the exterior panel 17 from being impaired.

### Modifications

The above-described embodiment may be modified as follows. The above-described embodiment and the following modifications can be combined as long as the combined modifications remain technically consistent with each other.

The protector 40 is not limited to the protector formed by joining the intermediate portion 40A and the pair of side portions 40B as exemplified in the present embodiment. For example, after the entire protector 40 is formed by extrusion molding, the connecting portions 45 may be formed by post-processing such as cutting. Further, the intermediate portion 40A and the portion of the protector 40 in which the connecting portions 45 are formed may be formed by extrusion, and the remaining portion may be formed by injection. Even in this case, the connecting portions 45 may be formed by post-processing.

The position of the connecting portions 45 in the protector 40 may be changed as appropriate. That is, the connecting portions 45 are not limited to being formed in each of the pair of side portions 40B, and may be formed in the intermediate portion 40A, for example. In this case, the connecting portions 45 formed in the side portion 40B may be omitted.

The connecting portions 45 are not limited to the ones that extend in the longitudinal direction and open downward at the peripheral edge of the exterior panel 17. For example, the connecting portions 45 may extend in the vehicle width direction and may be open on the right side or the left side at the peripheral edge of the exterior panel 17.

The connecting portions 45 may be omitted from the protector 40.

In the present embodiment, the protector 40 extending along the rear edge 21b and the pair of side edges 21c is exemplified, but the protector 40 may be an annular protector extending over the entire circumference of the peripheral edge 21.

The extending portion 44 of the protector 40 is not limited to the one in which the distal end surface 44a is flush with the outer surface 20a of the panel body 20 as exemplified in the present embodiment. In the protector 40, the position of the distal end surface 44a may be appropriately changed as long as the extending portion 44 covers the boundary B.

The contact portion 43 may be omitted from the protector 40.

The ridge 42 of the protector 40 is not limited to one continuously extending along the peripheral edge 21. The protector 40 may have multiple ridges 42 arranged at intervals along the peripheral edge 21. The ridge 42 may be omitted.

The colors of the decorative layer 30 and the protector 40 are not limited to black exemplified in the present embodiment, and may be changed as appropriate.

The exterior panel for a vehicle according to the present disclosure is not limited to one formed by the in-mold coating forming method as exemplified in the present embodiment. For example, the decorative layer may be formed of a film laminate obtained by laminating multiple films. In this case, the base material 22 may be injection-molded using the decorative layer as an insert member. Even in this case, since it is difficult to set the decorative layer to a position at which the decorative layer comes into contact with the parting line in order to suppress the decorative layer from being interposed between the parting lines, the base material 22 is exposed at the peripheral edge 21 of the panel body 20.

The exterior panel for a vehicle according to the present disclosure is not limited to the one attached to the outer panel 12 of the trunk lid 11 as illustrated in the present embodiment. The vehicle exterior panel according to the present disclosure can also be embodied as, for example, an exterior panel attached to other exterior members such as a front door and a roof panel.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior panel, comprising:
a panel body configured to be attached to an exterior member forming a part of an outer shell of a vehicle; and
a protector formed of an elastic material and extending along a peripheral edge of the panel body between the panel body and the exterior member, wherein
the panel body includes:
a base material made of a resin; and
a decorative layer laminated on an outer surface of the base material, and
the protector includes an extending portion that extends from between the panel body and the exterior member and covers, from an outer side, a boundary between the decorative layer and the base material, the boundary being located at the peripheral edge of the panel body.

2. The vehicle exterior panel according to claim 1, wherein
the protector has a connecting portion, and
the connecting portion connects an internal space surrounded by the exterior member, the protector, and the base material to an outside of the vehicle exterior panel.

3. The vehicle exterior panel according to claim 2, wherein
a vertical direction of the vehicle is simply referred to as a vertical direction, and
the connecting portion opens downward at a peripheral edge of the vehicle exterior panel.

4. The vehicle exterior panel according to claim 1, wherein
a groove that opens toward the protector is formed in an inner surface of the base material, and
a ridge to be fitted into the groove is formed in an outer surface of the protector.

5. The vehicle exterior panel according to claim 1, wherein
the protector is colored in a color identical to that of the decorative layer, and
a distal end surface of the extending portion is flush with an outer surface of the panel body.

6. The vehicle exterior panel according to claim 1, wherein
the exterior member is an outer panel that forms an outer shell of a trunk lid that opens and closes an opening of a luggage compartment of the vehicle,
a longitudinal direction of the vehicle is simply referred to as a longitudinal direction,
the panel body is provided at a position continuous with a rear edge of a rear window of the vehicle, and
an outer surface of the panel body is flush with an outer surface of the rear window.
